(19) United States
(12) Patent Application Publication
(10) Pub. No.: US 2002/0067062 A1
(43) Pub. Date: Jun. 6, 2002

(54) Pivot mechanism

(76) Inventor: Philip Charles Shephard, Coventry (GB)

Correspondence Address: MERCHANT & GOULD P.C., P.O. Box 2903, Minneapolis, MN, 55402-0903, US

(21) Appl. No.: 09/828,704

(22) Filed: Apr. 6, 2001

Related U.S. Application Data
(60) Provisional application No. 60/242,053, filed on Oct. 20, 2000.

(30) Foreign Application Priority Data
Oct. 12, 2000 (GB) 0025020.9
Jan. 15, 2001 (GB) 0101007.3

(51) Int. Cl. B60N 2/02

(52) U.S. Cl. 297/366

(57) ABSTRACT

A pivot mechanism includes a pivot arm (14) that is rotatably mounted on a base member (1) via a pivot pin (16). The pivot mechanism includes a locking mechanism comprising a convex tooth segment (36) provided on the pivot arm and a locking member (38) having a concave tooth segment (40). The locking member (38) is mounted on the base member (1) for movement between a locked position in which the convex and concave tooth segments are engaged preventing rotation of the pivot arm (14), and an unlocked position in which the tooth segments are disengaged. The center of curvature of the convex tooth segment (36) is offset from the center of curvature of the concave tooth segment (40) whereby, in normal usage, the convex and concave tooth segments are only partially engaged when the locking member is in the locked position.

The present invention relates to a pivot mechanism and in particular, but not exclusively, to a pivot mechanism for use in a seat recliner mechanism. The invention also relates to a recliner mechanism and a vehicle seat including such a mechanism.

Many vehicle seats include a tilting/tipping mechanism that allows the angle of the seat back (or “squab”) to be adjusted. The squab is generally attached to the seat base through a pivot mechanism that includes a locking mechanism for locking the squab at the desired angle.

In one such pivot mechanism, for example as described in DE-OS-2931873, the squab is attached to a pivot arm that is provided with a set of ratchet teeth. Those teeth are engaged by a locking plate having a complementary set of teeth. The locking plate can be moved away from the pivot arm to disengage the two sets of teeth, allowing the angle of the squab to be adjusted, and can the be moved back towards the pivot arm, to engage the teeth and lock the squab in position.

The pivot mechanism naturally has to be able to withstand a number of forces during normal use including in particular the rearwards force caused by a passenger leaning against the squab. However, for safety and to comply with worldwide legislation, it also has to be able to withstand the much greater forces that might be generated if the vehicle is involved in a collision. In particular, if the squab carries the upper anchoring point for the seat belt, a very large forwards force may be generated in the event of a frontal collision, owing to the inertia of the passenger. Such transient forces may be many times greater than the forces experienced during normal usage and the pivot mechanism must be able to withstand them without collapsing.

The very large forces generated by a collision can cause plastic deformation of the pivot mechanism. For example, the pivot pin on which the pivot arm is mounted may be driven forwards, causing partial separation of the two sets of teeth forming the locking mechanism. The forces carried by the locking mechanism may then be concentrated on just one or two of the teeth, causing those teeth to fail, followed by sequential failure of all the remaining teeth as the load is transferred to them (the so-called “domino effect”).

It is an object of the present invention to provide a pivot mechanism that mitigates at least some of the disadvantages of prior art pivot mechanisms.

According to the present invention there is provided a pivot mechanism including a pivot arm rotatably mounted on a base member via a pivot pin, and a locking mechanism including a convex tooth segment provided on the pivot arm and a locking member having a concave tooth segment, the locking member being mounted on the base member for movement between a locked position in which the convex and concave tooth segments are engaged preventing rotation of the pivot arm and an unlocked position in which the tooth segments are disengaged; characterised in that the centre of curvature of the convex tooth segment is offset from the centre of curvature of the concave tooth segment whereby, in normal usage, the convex and concave tooth segments are only partially engaged when the locking member is in the locked position.

Owing to the offset of the centres of curvature, the mechanism is able to absorb some plastic deformation without failing. The deformation has the effect of driving more of the teeth into engagement, thereby spreading the load between the tooth segments and increasing the strength of the locking mechanism.

Advantageously, the point of engagement between the tooth segments is towards one end of the concave tooth segment, which in the case of a pivot mechanism for a vehicle seat is the rear end of the tooth segment. This gives the mechanism greater strength in one direction than the other, which is important in situations where the pivot mechanism is more likely to encounter very large loads in one direction than another, for example in a vehicle that is involved in a collision. In many countries, these load bearing characteristics are dictated by legislation. The off-centre location of the engagement point also serves to remove free play from the mechanism and compensates automatically for both tolerance and wear.

The degree and direction of offset depends on the design criteria including the balance of the strength requirements for loads acting in different directions on the mechanism, and the dimensions and load-bearing characteristics of the other components of the mechanism.

Advantageously, the effective radius of the concave tooth segment is larger than the effective radius of the convex tooth segment. The ratio of the effective radii may be in the range 1.0-1.3, preferably 1.1-1.2, more preferably approximately 1.15.

Advantageously, the centres of curvature of the convex and concave tooth segments are located on a line that is substantially radial to both tooth segments, and said line intersects the concave tooth segment towards one end thereof, which in the case of a pivot mechanism for a vehicle seat is the rear end of the tooth segment.

According to a further aspect of the invention there is provided a recliner mechanism for a vehicle seat having a seat base and a reclining squab, said recliner mechanism including a pivot mechanism as described in one of the preceding claims.

According to a further aspect of the invention there is provided a vehicle seat including a seat base and a reclining squab that is attached to the seat base by means of a recliner mechanism according to the preceding paragraph.

Embodiments of the invention will now be described by way of example with reference to the accompanying drawings, in which:

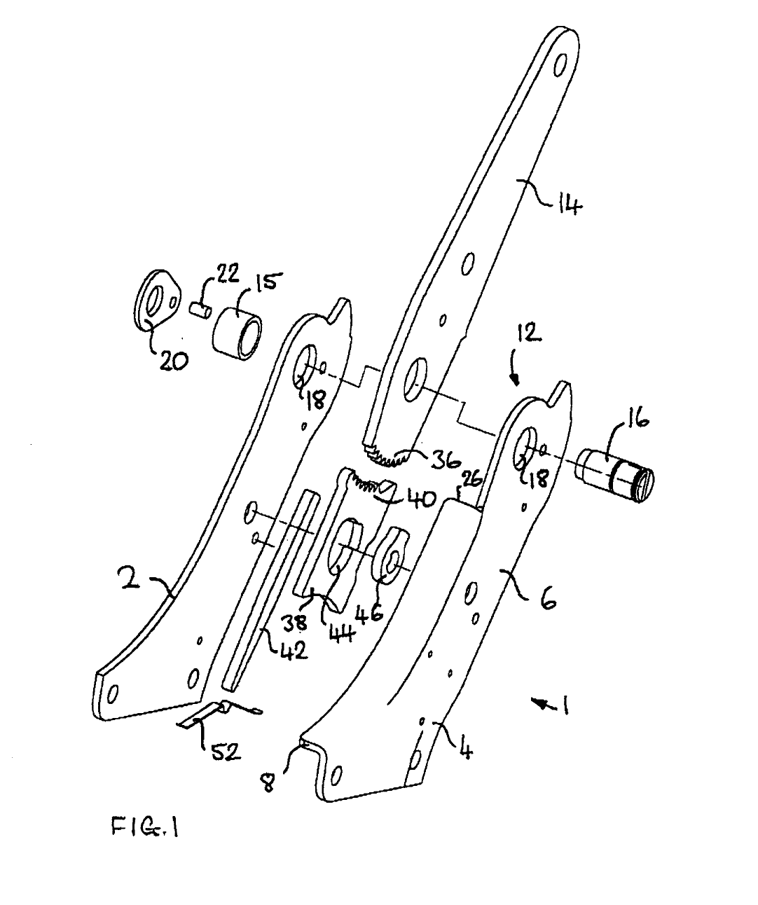

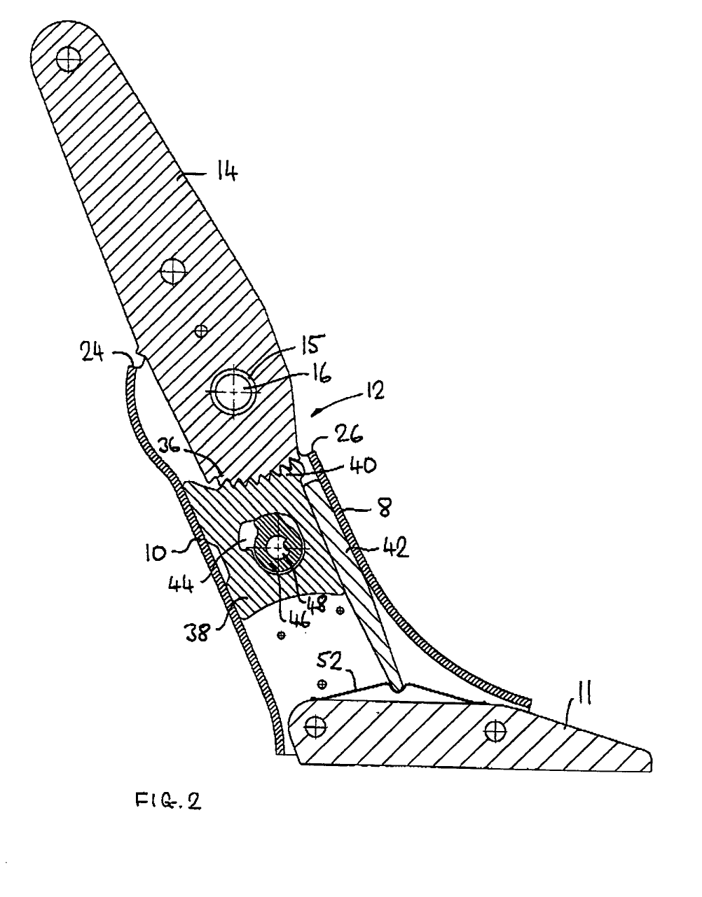

FIG. 1 is an exploded isometric view of a first pivot mechanism according to the invention;

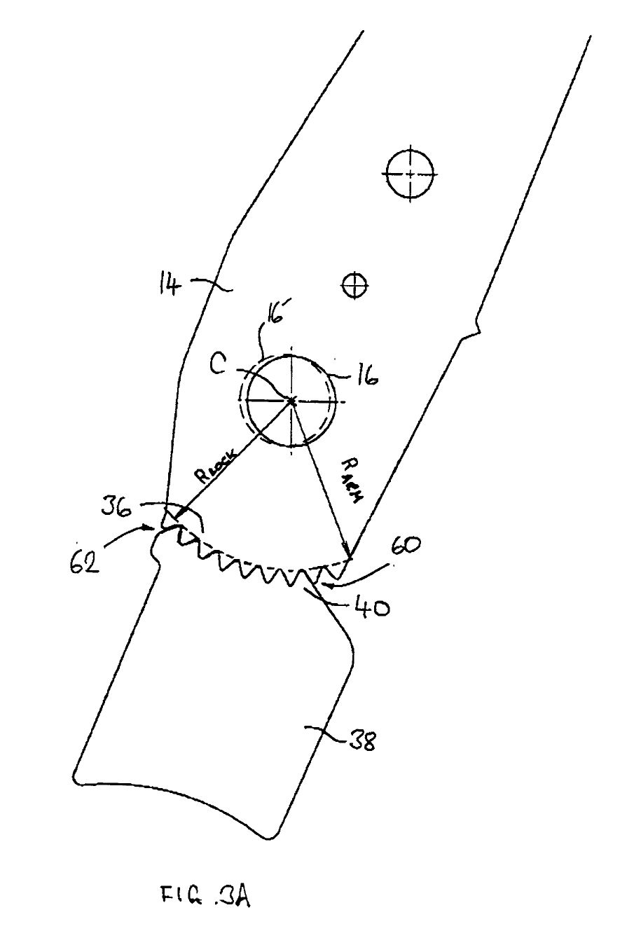

FIG. 2 is a sectional side view of the first pivot mechanism;

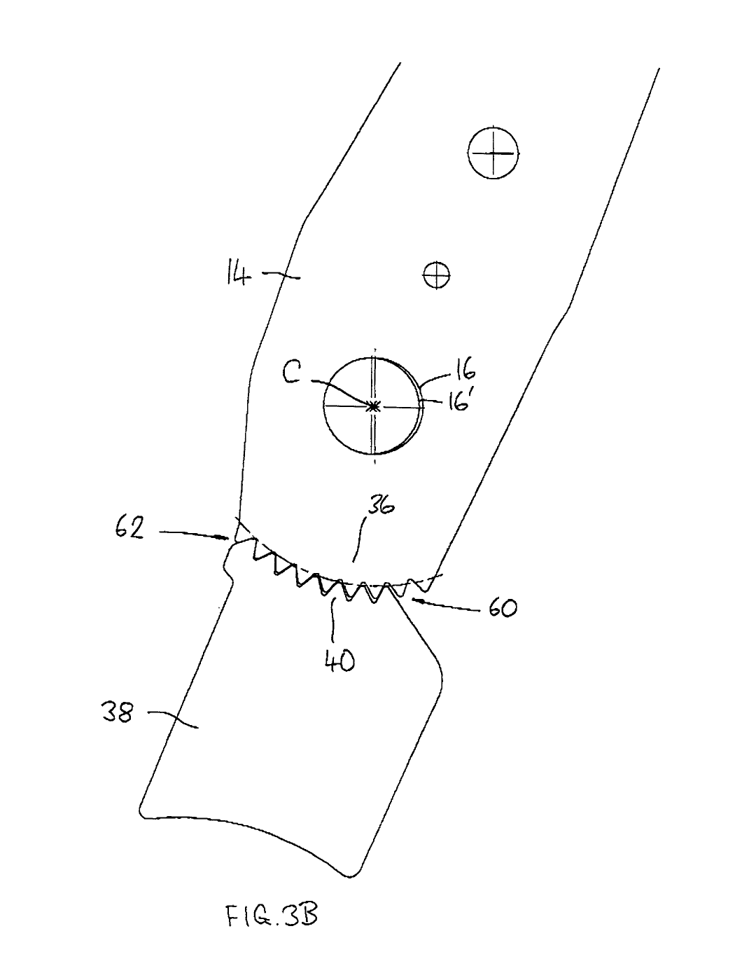

FIGS. 3A and 3B are partial schematic side views of a prior art pivot mechanism, before and after deformation;

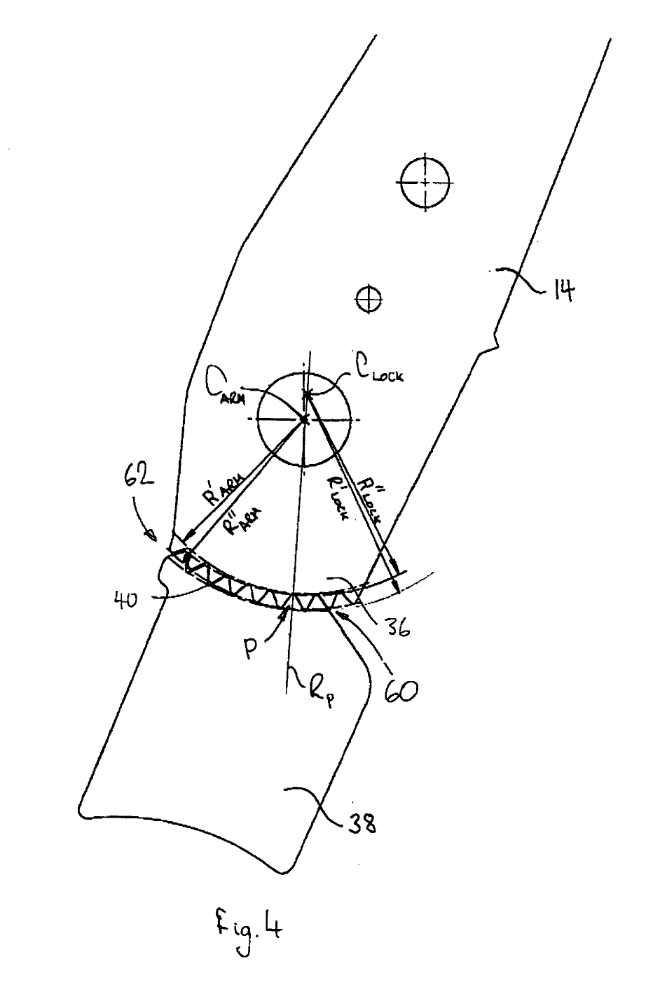

FIG. 4 is a partial schematic side views of the first pivot mechanism;

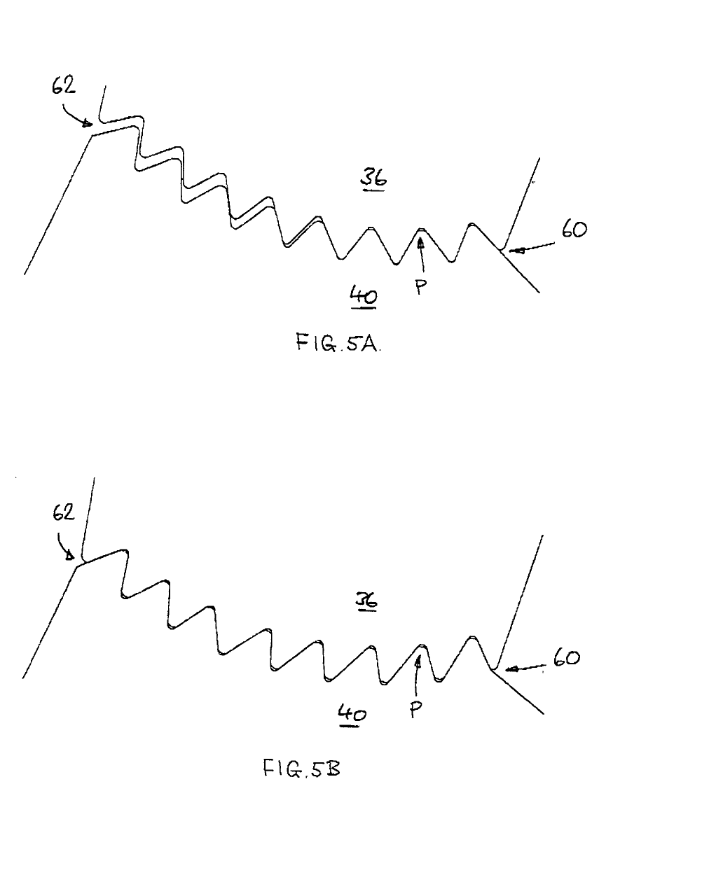

FIGS. 5a and 5b are enlarged partial schematic side views of the first pivot mechanism, showing the mechanism before and after a collision causing plastic deformation of the mechanism;

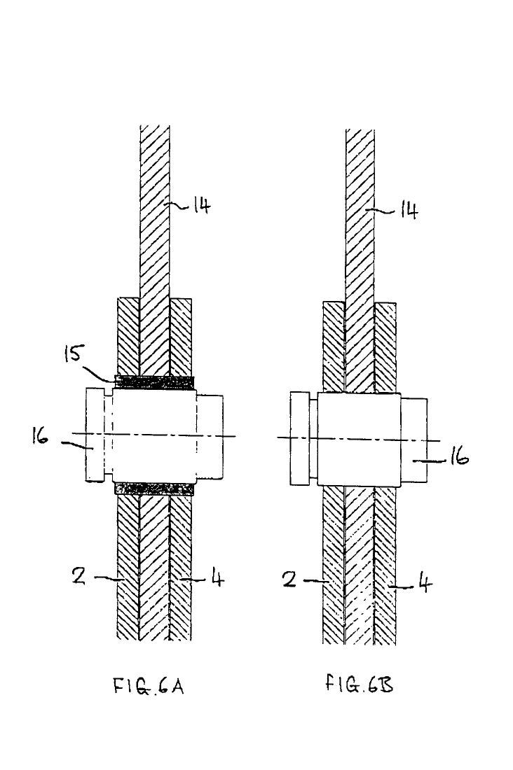

FIG. 6A is a sectional front view at an enlarged scale, showing the pivot pin and sleeve of the first pivot mechanism;

FIG. 6B is a sectional front view showing the pivot pin of a modified pivot mechanism;

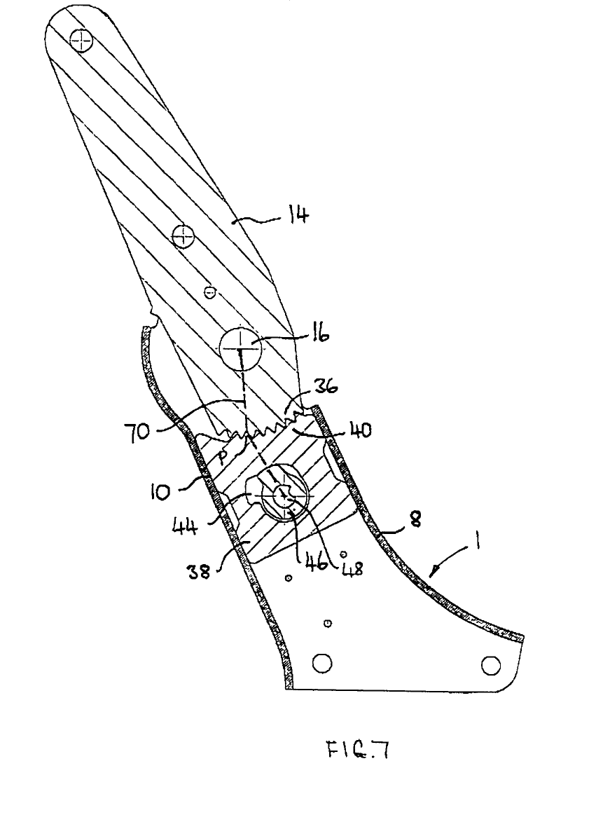

FIG. 7 is a sectional side view of a second pivot mechanism according to the invention.

A pivot mechanism according to the invention is shown generally in FIGS. 1 and 2 of the drawings. The pivot mechanism is similar in most respects to the mechanism described in our British patent application No. 0104334.8, the content of which is incorporated by reference herein.

Each reclining vehicle seat may include two such pivot mechanisms, which are interlinked and mounted on either side of the seat and join the reclining squab to the seat base, preferably at the extremities (the widest point) of the seat. Alternatively, the seat may include a pivot mechanism as shown in the drawings on just one side and a plain pivot on the opposite side. In practice, the mechanism will normally be covered, either by the upholstery of the seat or by a rigid cover.

The pivot mechanism includes a housing 1 formed from two steel plates, those being a flat closing plate 2 and a pressed plate 4 that has a shallow U-shaped cross-section, comprising a substantially flat side plate 6 and front and rear peripheral walls 8,10 that extend towards the flat closing plate 2. The plates 2,4 are welded together along the free edges of the peripheral walls 8,10 forming a very strong box-section.

The housing 1 is roughly boot-shaped and is secured at its lower end (the sole of the “boot”) to a mounting member 11 that is attached to one of the seat slides or to the seat base. The housing 1 is thus fixed relative to the seat base. Alternatively, the housing 1 may be attached direct to the slide or seat base. Towards the upper end of the housing (at the knee of the “boot”), a gap is provided between the front and rear peripheral walls 8,10 forming an opening 12 into the housing.

A pivot arm 14 made of steel plate, which in use is attached to and supports the seat back (or “squab”), extends through the opening 12 and is mounted via a sleeve 15 on a pivot pin 16 that extends through the housing and is located in corresponding openings 18 in the side plates 2,4. The sleeve 15, which serves as a stress relief bush and is described in more detail below, may be omitted if not required.

One end of the pivot pin 16 is welded or fixed to a pin head 20, which is secured to the side plate 2 by a reaction pin 22 to prevent rotation of the pivot pin. This mounting method avoids welding onto the side plate 2 and thus avoids compromising the material integrity of the plate, ensuring maximum housing strength. It also allows the pivot pin 16 to be demounted.

Pivoting movement of the pivot arm 14 about the pin 16 is limited by engagement of the arm with the front and rear peripheral walls 8,10 at the edges of the opening 12. Thus, rearwards or reclining movement is limited by the arm engaging a first stop surface 24 on the rear peripheral wall 10, and forwards or tipping movement of the arm is limited by the arm engaging a second stop surface 26 on the front peripheral wall 8.

A clock spring (not shown) may be mounted on the second end of the pivot pin 16 that extends outwards beyond the housing 1. The spring is connected to the pivot arm 14 and biasses the squab towards an upright position from a reclined position.

The pivot arm 14 may be locked in a number of different reclined positions by means of a locking mechanism. A first set of teeth forming a convex tooth segment 36 is provided at the lower end of the pivot arm 14. A locking member 38 comprising a metal plate having a second set of teeth forming a concave tooth segment 40 is located below the pivot arm and mounted for up and down sliding movement within the housing 1, between the rear peripheral wall 10 and a glide block 42, which is located between the locking member 38 and the front peripheral wall 8.

The locking member 38 has a central opening 44 that serves as a cam follower arrangement. This opening encloses and is engaged by a rotatable cam element 46. The cam element 46 is mounted on a second pivot pin 48 that extends through the housing 1.

When the cam element 46 is in the position shown in FIG. 2, the concave tooth segment 40 on the locking member 38 is locked in engagement with the convex tooth segment 36 provided at the lower end of pivot arm 14, thereby preventing movement of the arm. To release the locking element, the cam element 46 is rotated from that position anticlockwise through an angle of approximately 90°. This draws the locking member 38 downwards so that the concave tooth segment 40 disengages the convex tooth segment 36 on the pivot arm 14. The seat squab can then be rotated to a different angle.

The average segment tooth angle for the two sets of teeth preferably lies in the range 50° to 75°, and is preferably approximately 60°. If the angle is less than 50° the teeth may be too weak to withstand the stresses placed upon them, particularly in the event of a collision, whereas if the angle is greater than 75° the forces tending to push the sets of teeth apart when the mechanism is loaded may be too large to be contained by the housing.

The front and rear peripheral walls 8,10 converge upwards at a small angle of convergence, and the glide block 42 is wedge-shaped, having front and rear surfaces that converge upwards at the same small angle. The inner face of the glide block 42 is therefore parallel to the rear peripheral wall 10. This allows the locking member 38 to slide between those surfaces, movement of the locking member 38 being guided by the rear peripheral wall 10 and the rear surface of the glide block 42.

The glide block 42 is capable of sliding movement relative to the housing 1 and is biassed upwards by a leaf spring 52 that sits on the upper edge of the mounting member 11. This produces a wedging action, which ensures that there is no fore-and-aft free play in the mechanism. The mechanism thus compensates automatically for wear and tear and prevents judder and rattle.

FIG. 3A of the drawings shows schematically the pivot mechanism described in our earlier British patent application No. 0104334.8. The radius of curvature Rₐᵣₘ of the convex tooth segment 36 provided at the lower end of the pivot arm 14 is exactly matched to the radius of curvature R_{lock} of the concave tooth segment 40 provided on the locking member 38, and both tooth forms have the same centre of curvature C. As a result, the two sets of teeth mesh perfectly, providing theoretically the highest possible load bearing capacity.

We have found that in the event of a frontal collision, the pivot mechanism can experience plastic deformation, owing to the very high transient forces transmitted through it from the inertial-loading of a passenger secured to the squab by a seat belt, or luggage stowed behind the squab. Typically, as the mechanism is deformed, the holes 18 in the housing become elongated allowing the pivot pin 16 to move forwards from its original position 16 to a new position 16′ shown in broken lines. This causes the tooth segments 36,40 to separate slightly, leaving a small gap between the two tooth segments at the rear edge 60 of the mechanism, as shown in FIG. 3B.

As a result of this deformation, the teeth towards the rear edge 60 of the tooth segments may no longer fully engage each other. The entire load will therefore be borne by one or two teeth at the front edge 62 of the tooth segments, rather than being spread evenly over the whole length of the two tooth segments. If that load is too great for the front teeth to bear, they will deform and fail. The load will then be transferred to the next teeth, which may also deform and fail, and this process may continue, leading to sequential failure of all the teeth and collapse of the entire locking mechanism.

In the present invention, this problem is avoided by using a modified tooth form, as shown in FIG. 4. In this modified tooth form, the radii of curvature of the two tooth segments are not matched, and the centres of curvature of the tooth segments are offset from one another.

The curvature of a tooth segment may be defined in terms of its effective radius (R*), which is normally equal to the mean of the inner and outer tooth radii, measured from the centre of curvature C to the roots and the tips of the teeth: i.e.,

R*=(R′+R″)/2

where R′=the radius of curvature to the tooth roots and R″=the radius of curvature to the tooth tips.

In the example shown in FIG. 4, the effective radius of the convex tooth segment 36 on the arm 14 is slightly less than the effective radius of the concave tooth segment 40 on the locking member 38: i.e.,

R*ₐᵣₘ<R*_{lock}

where R*ₐᵣₘ is the effective radius of the arm 14 and R*_{lock} is the effective radius of the locking member 38.

Typical values for these radii are as follows:

| | | | | |
|---|---|---|---|---|
| Arm: | R′ₐᵣₘ | = | 43.07 | mm, |
| | R″ₐᵣₘ | = | 46.8 | mm, |
| | R*ₐᵣₘ | = | 44.94 | mm |
| Locking member: | R″_{lock} | = | 49.63 | mm, |
| | R′_{lock} | = | 53.45 | mm, |
| | R*_{lock} | = | 51.54 | mm |

In this case. the ratio of the effective radii (R*_{lock}/R*ₐᵣₘ) is equal to approximately 1.15. It will be appreciated however that the radii in any particular case will depend on the specified load bearing requirements and the dimensions and structure of the other components of the mechanism.

To accommodate the different effective radii, the centres of curvature are offset, the centre of curvature Cₐᵣₘ of the convex tooth segment 36 being located closer to the teeth than the centre of curvature C_{lock} of the concave tooth segment 40. The radial separation of the two centres of curvature is equal to the difference between the effective radii, so that the teeth mesh correctly at one point, referred to herein as the “engagement point” P.

Preferably, in forward-facing set applications, the engagement point P is located in the rear half of the locking member 38, between the centre of the concave tooth segment 40 and its rear edge 60. For example, as shown in FIG. 4a, the engagement point P may coincide with the second tooth from the rear edge of the concave tooth segment 40. The centres of curvature of the arm Cₐᵣₘ and the locking member C_{lock} are therefore located on a radius R_{P} that intersects the tip of that tooth.

As shown more clearly in FIG. 5a, the two segments 36,40 mesh correctly at the engagement point P, but are not fully engaged forward and rearwards of that point, the gap between the tooth segments being larger at the front edge 62 of the locking member 38 than at the rear edge 60. Nevertheless, the engagement between the two segments is sufficiently strong to withstand the forces and wear encountered during normal usage.

Should the vehicle be involved in a frontal collision, there may be some plastic deformation of the pivot mechanism, the result of which is shown in FIG. 5b. The pivot pin has been displaced forwards from its usual position and, as a result, the teeth towards the front edge 62 of the pivot arm 40 have been brought into engagement with the corresponding teeth of the locking member 36, thereby increasing the number of teeth in contact. The forces are therefore shared between a increased number of teeth, so reducing the likelihood of the teeth failing. There has also been some deformation of the teeth around the original engagement point P, but this is not sufficiently serious to cause those teeth to fail.

The locking mechanism is therefore able to meet the specified load requirements more efficiently, and its strength increases with the severity of the crash. Testing has shown that the arrangement described above significantly increases the strength of the mechanism.

The sleeve 15 that surrounds the pivot pin 16 is shown in more detail in FIG. 6A. It extends through the housing plates 2,4 and the pivot pin 16 and is designed to relieve stress around the openings 18 in the housing plates, thereby reducing plastic deformation and increasing the strength of the mechanism. The sleeve 15 may however be omitted if not required, as shown in FIG. 6B

A second embodiment of the invention is shown in FIG. 7. In this embodiment, the wedge-shaped glide block 42 is omitted and the locking member 38 is instead mounted for sliding movement between the front peripheral wall 8 and the rear peripheral wall 10.

As in the previous example shown in FIG. 4, the effective radius of the convex tooth segment 36 on the arm 14 is slightly less than the effective radius of the concave tooth segment 40 on the locking member 38, and the centres of curvature are offset, the centre of curvature of the convex tooth segment being located closer to the teeth than the centre of curvature of the concave tooth segment. In this example, the engagement point P coincides with the second tooth from the rear edge of the concave tooth segment 40. The two tooth segments 36,40 mesh correctly at the engagement point P, but are not fully engaged forward and rearwards of that point, the gap between the tooth segments being larger at the front edge of the locking member 38 than at the rear edge.

The locking member 38 has a central opening 44, which is engaged by a rotatable cam element 46. When the cam element is in the “locked” position shown in FIG. 7, it exerts an upwards force on the locking member, which is transmitted through the pivot arm 14 to the pivot pin 16. That force is transmitted through the engagement point P, the direction of that force being shown by a broken line 70. The engagement point P does not lie on a straight line intersecting the axes of the pivot pin 16 and the cam element 46. Instead, the engagement point P is located in the rear half of the locking member, and the line 70 along which the compressive force is transmitted is therefore bent. The compressive force therefore generates a resultant force on the locking member 38 that presses it hard against the rear peripheral wall 10.

The effect of this resultant force is to remove any free play between the locking member and the housing 1. The mechanism therefore compensates automatically for both tolerance and wear, without the need for the sliding wedge member 42 of the first embodiment shown in FIGS. 1 and 2.

Various modifications of the invention are possible, some of which will now be described.

Although it is preferred that the radii of curvature of the two tooth segments are not matched, and the centres of curvature of the tooth segments are offset from one another, it may be sufficient in certain circumstances just to offset the centres of curvature, for example by moving the pivot point backwards, while maintaining the same radii of curvature for both tooth segments. This will create a small gap between the two tooth segments at the front edge of the locking member, which will close when the mechanism suffers plastic deformation in a collision.

Alternatively, the same effect may be achieved by using teeth of different sizes, so that they become fully engaged only when the mechanism is deformed owing to very high load forces.

Instead of the symmetrical teeth shown in the drawings, the tooth segments may be provided with asymmetric (saw tooth) teeth, so that they can withstand a greater force in the forward direction without separation than in the rearwards direction. This increases the ability of the mechanism to survive a serious frontal collision without collapsing.

In the mechanism shown in the accompanying drawings, the locking member 38 is located in the housing 1 that is attached to the seat base and the pivot arm 14 is attached to the squab. It should however be understood that the mechanism may be inverted, so that the pivot arm 14 is attached to the seat base and the housing 1 is attached to the squab. The pivot arm 14 will then remain stationary whilst the housing 1 and the locking member 38 rotate with the squab about the axis of the pivot pin 16. This arrangement may be preferred when, for example, a control handle for operating the cam element 48 is to be located at the top of the squab rather than on the seat base.

Instead of a box section, the housing 1 may for example comprise two flat plates joined together with rivets, or a single plate or a frame to which the other components are attached. The cam element 48 may be located in other positions, for example beneath the locking member 38. Further, the mechanism may be made from different materials, including other metals and metal alloys, plastics materials and composite materials.

Although the pivot mechanism is particularly suited to use in a seat recliner mechanism, it is not restricted to that use. It may also be used in various other mechanisms and industries including, for example, work benches, cranes, gearboxes, nano-mechanisms, mechanism counting devices, clock and watch mechanisms, inertia locking systems, brake or clutch compensating mechanisms and any other ratchet applications where two centres try to move apart when subjected to a load.

1. A pivot mechanism including a pivot arm rotatably mounted on a base member via a pivot pin, and a locking mechanism including a convex tooth segment provided on the pivot arm and a locking member having a concave tooth segment, the locking member being mounted on the base member for movement between a locked position in which the convex and concave tooth segments are engaged preventing rotation of the pivot arm and an unlocked position in which the tooth segments are disengaged; characterised in that the centre of curvature of the convex tooth segment is offset from the centre of curvature of the concave tooth segment whereby, in normal usage, the convex and concave tooth segments are only partially engaged when the locking member is in the locked position.

2. A pivot mechanism according to claim 1, in which the point of engagement between the tooth segments is towards one end of the concave tooth segment.

3. A pivot mechanism according to claim 1, in which the effective radius of the concave tooth segment is larger than the effective radius of the convex tooth segment.

4. A pivot mechanism according to claim 3, in which the ratio of the effective radii is in the range 1.0-1.3, preferably 1.1-1.2, more preferably approximately 1.15.

5. A pivot mechanism according to any one of the preceding claims, in which the centres of curvature of the convex and concave tooth segments are located on a line that is substantially radial to both tooth segments, and said line intersects the concave tooth segment towards one end thereof.

6. A recliner mechanism for a vehicle seat having a seat base and a reclining squab, said recliner mechanism including a pivot mechanism according to any one of the preceding claims.

7. A vehicle seat including a seat base and a reclining squab that is attached to the seat base by means of a recliner mechanism according to claim 6.
